(19) United States
(12) Patent Application Publication
(10) Pub. No.: US 2011/0035204 A1
(43) Pub. Date: Feb. 10, 2011

(54) Layered Modeling for High-Level Synthesis of Electronic Designs

(76) Inventors: Maxim Smirnov, Wilsonville, OR (US); Andres Takach, Wilsonville, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/834,874

(22) Filed: Jul. 12, 2010

Related U.S. Application Data
(60) Provisional application No. 61/224,470, filed on Jul. 10, 2009.

(51) Int. Cl. G06F 17/50

(52) U.S. Cl. 703/14

(57) ABSTRACT

Methods and apparatuses for modeling and simulating a high-level circuit design are provided. With some implementations of the invention, a layered model corresponding to an algorithmic description for a circuit design is generated. The layered model includes a set of threads that describe the behavior of the circuit design, a schedule that describes timing constraints of the circuit design, and interfaces that facilitate the transfer of data between various layered models. With some implementations, a layered model may also include a shared variable that facilitates the transfer of data between ones of the set of threads within a layered model.

### RELATED APPLICATIONS

This application claims priority under 35 U.S.C. §119(e) to U.S. Provisional Patent Application No. 61/224,470 entitled “SystemC Superset for High-Level Synthesis,” filed on Jul. 10, 2009, and naming Maxim Smirnov and Andres Takach as inventors, which application is incorporated entirely herein by reference.

### FIELD OF THE INVENTION

The invention relates to the field of electronic device design. More specifically, various implementations of the invention are directed towards modeling and simulating the operation of an electronic design based upon a high-level description of the electronic design.

### BACKGROUND OF THE INVENTION

Today, the design of electronic devices no longer begins with diagramming an electronic circuit. Instead, the design of modern electronic devices, and particularly integrated circuits (“IC's”), often begins at a very high level of abstraction. For example, a design may typically start with a designer creating a specification that describes particular desired functionality. This specification, which may be implemented in C, C++, SystemC, or some other programming language, describes the desired behavior of the device at a high level. Device designs at this level of abstraction are often referred to as “algorithmic designs,” “algorithmic descriptions,” or “electronic system level (“ESL”) designs”. Designers then take this algorithmic design, which may be executable, and create a logical design through a synthesis process. The logical design will often be embodied in a netlist. Frequently, the netlist is a register transfer level (“RTL”) netlist.”

Designs at the register level are often implemented by a hardware description language (“HDL”) such as SystemC, Verilog, SystemVerilog, or Very High speed hardware description language (“VHDL”). A design implemented in HDL describes the operations of the design by defining the flow of signals or the transfer of data between various hardware components within the design. For example, an RTL design describes the interconnection and exchange of signals between hardware registers and the logical operations that are performed on those signals.

Designers subsequently perform a second transformation. This time, the register transfer level design is transformed into a gate level design. Gate level designs, like RTL designs, are also often embodied in a netlist, such as, a mapped netlist for example. Gate level designs describe the gates, such as AND gates, OR gates, and XOR gates that comprise the design, as well as their interconnections. In some cases, a gate level netlist is synthesized directly from an algorithmic description of the design, in effect bypassing the RTL netlist stage described above.

Once a gate level netlist is generated, the design is again taken and further transformations are performed on it. First the gate level design is synthesized into a transistor level design, which describes the actual physical components such as transistors, capacitors, and resistors as well as the interconnections between these physical components. Second, place and route tools then arrange the components described by the transistor level netlist and route connections between the arranged components. Lastly, layout tools are used to generate a mask that can be used to fabricate the electronic device, through for example an optical lithographic process.

Designers additionally implement various verification processes on the circuit design. These verification processes are typically implemented on each newly synthesized design, such as, for example, an RTL netlist. Furthermore, designers often endeavor to perform benchmarking or system performance evaluation on the circuit design. As modern circuit designs are becoming increasingly complex, it is often advantageous to perform these verification and benchmarking tasks earlier in the development cycle. Additionally, it is often necessary that the verification and benchmarking tasks take place in a hardware software co-development environment.

### SUMMARY OF THE INVENTION

Various implementations of the invention provide methods and apparatuses for modeling and simulating a high-level circuit design. In some implementations of the invention, a layered model corresponding to an algorithmic description for a circuit design is generated. The layered model includes a set of threads that describe the behavior of the circuit design, a schedule that describes timing parameters of the circuit design, and interfaces that facilitate the transfer of data between various layered models. With some implementations, a layered model may also include a shared variable that facilitates the transfer of data between ones of the set of threads within a layered model.

### BRIEF DESCRIPTION OF THE DRAWINGS

The present invention will be described by way of illustrative embodiments shown in the accompanying drawings in which like references denote similar elements, and in which:

FIG. 1 shows an illustrative computing environment;

FIG. 2 illustrates a layered modeling design flow;

FIG. 3 a layered model;

FIG. 4 illustrates a portion of the layered model of FIG. 3 in greater detail;

FIG. 5A illustrates a free-running thread;

FIG. 5B illustrates an event activated thread;

FIG. 6 illustrates a schedule;

FIG. 7 illustrates a thread; and

FIG. 8 illustrates a layered model generation tool.

### DETAILED DESCRIPTION OF ILLUSTRATIVE EMBODIMENTS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed methods. Such terms are often high-level abstractions of the actual operations that are performed. The actual operations that correspond to these terms will often vary depending on the particular implementation, and will be readily discernible by one of ordinary skill in the art.

Furthermore, in various implementations of the invention, a mathematical model may be employed to represent an electronic device. With some implementations, a model describing the connectivity of the device, such as for example a netlist, is employed. Those of skill in the art will appreciate that the models, even mathematical models represent real world device designs and real world physical devices. Accordingly, manipulation of the model, even manipulation of the model when stored on a computer readable medium, results in a different device design. More particularly, manipulation of the model results in a transformation of the corresponding physical design and any physical device rendered or manufactured by the device design. Additionally, those of skill in the art can appreciate that during many electronic design and verification processes, the response of a device design to various signals or inputs is simulated. This simulated response corresponds to the actual physical response the device being modeled would have to these various signals or inputs.

Some of the methods described herein can be implemented by software stored on a computer readable storage medium, or executed on a computer. Accordingly, some of the disclosed methods may be implemented as part of a computer implemented electronic design automation (“EDA”) tool. The selected methods could be executed on a single computer or a computer networked with another computer or computers. For clarity, only those aspects of the software germane to these disclosed methods are described; product details well known in the art are omitted

### Illustrative Computing Environment

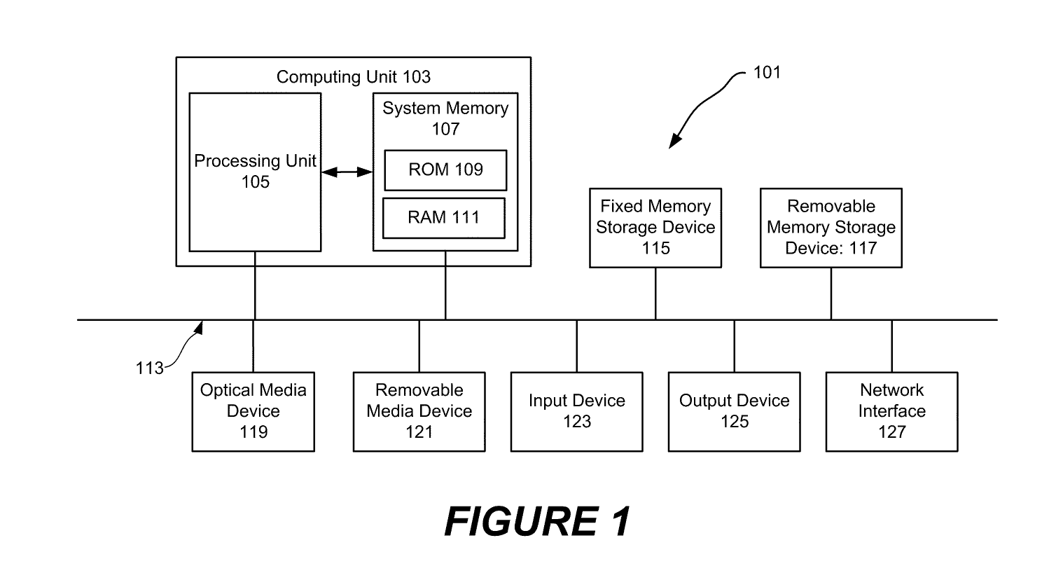

As the techniques of the present invention may be implemented using software instructions, the components and operation of a generic programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### High-Level Synthesis Modeling

As stated above, modern electronic designs often start as abstract and un-timed models, which are later synthesized into register transfer level models. Verification of these synthesized models requires simulation of the models. This simulation may be carried out at various levels of abstraction or various levels of timing accuracy. More particularly, loosely-timed (LT) models provide fast models of a circuit design, which enables early development of software for the device, such as for example, firmware for an embedded hardware device. Conversely, approximately-timed (AT) models provide more accurate timing at the expense of simulation speed, which would delay the development of software for the device.

One benefit to using high-level synthesis comes from the high-level of abstraction with a clear separation between algorithm and implementation constraints that define cycle timing, hardware interfaces and overall micro-architecture of the generated hardware. The functionality of a block or subsystem can typically be specified at a high level of abstraction where the cycle timing is not an integral part of the intrinsic functionality (algorithm). The cycle timing is added by synthesis based on implementation constraints that include interface synthesis. When specifying an entire system, however, the designer is providing some macro-architectural details of the systems where cycle timing of individual blocks may affect the functionality of the overall system. The ultimate goal is to be able to specify, verify and synthesize the system in its entirety. The requirement to achieve that goal is to provide an executable specification of the system that can be validated, synthesized, and the resulting hardware verified against the executable specification. An additional requirement on the executable specification is that it needs to be easily configurable for different levels of timing accuracy, such as, for example loosely-timed, to enable using it for firmware or embedded software development.

Specification styles for high-level synthesis that are based on sequential C or C++ deliver a high level of model abstraction and portability, but do not allow for the parallelism necessary for describing design hierarchy of concurrent systems, arbitration and time-dependant algorithms. This drawback limits the applicability of such styles to block or subsystem-level high-level synthesis.

Specification styles based on SystemC make extensive use of wait-on-clock statements. This specification style does not provide a sufficient separation of function from cycle timing as wait statements constrain all Input and Output (I/O) assignments that precede the wait from all the I/O assignments that succeed the wait. As a result, the use of wait statements unnecessarily constrains I/O and inhibits the high-level synthesis process from being able to perform important optimizations such as loop pipelining and interface optimizations. This is discussed more fully in A Methodology for Correct-by Construction Latency Insensitive Design, by L. P. Carloni et al., Proceedings of the 1999 IEEE/ACM International Conference on Computer Aided Design, 1999, pp. 309-315, which article is incorporated entirely herein by reference. One significant drawback to high-level synthesis using a specification style based on SystemC is that the generated register transfer level netlists are not guaranteed to match the specification, even though all the blocks of a system are synthesized correctly. Furthermore, the use of wait statements implies context switching during simulation, which significantly slows it down making the use of such behavioral models impractical for their intended purpose. Additionally, non-synthesizable code must often be inserted into the specification to facilitate simulation.

### Layered Modeling for High-Level Synthesis

The various implementations and embodiments described below make reference to high-level synthesis techniques, particularly applicable to SystemC, some of the references made make use of technology or principals described in some detail in: Object-Oriented High-Level Synthesis Based on SystemC, by E. Grimpe and F. Oppenheimer, Proceedings of ICECS, 2001, pp. 529-534; Extending the SystemC Synthesis Subset by Object-Oriented Features, by E. Grimpe and F. Oppenheimer, Proceedings of the 1^{st} IEEE/ACM/IFIP International Conference on Hardware/Software Codesign and System Synthesis, 2003, pp. 25-30; and Concepts of High Level Synthesis Using SystemC, 2002, ISSN 1392-2114 ULTRAGARSAS, Nr.2 (43); which articles are all incorporated entirely herein by reference.

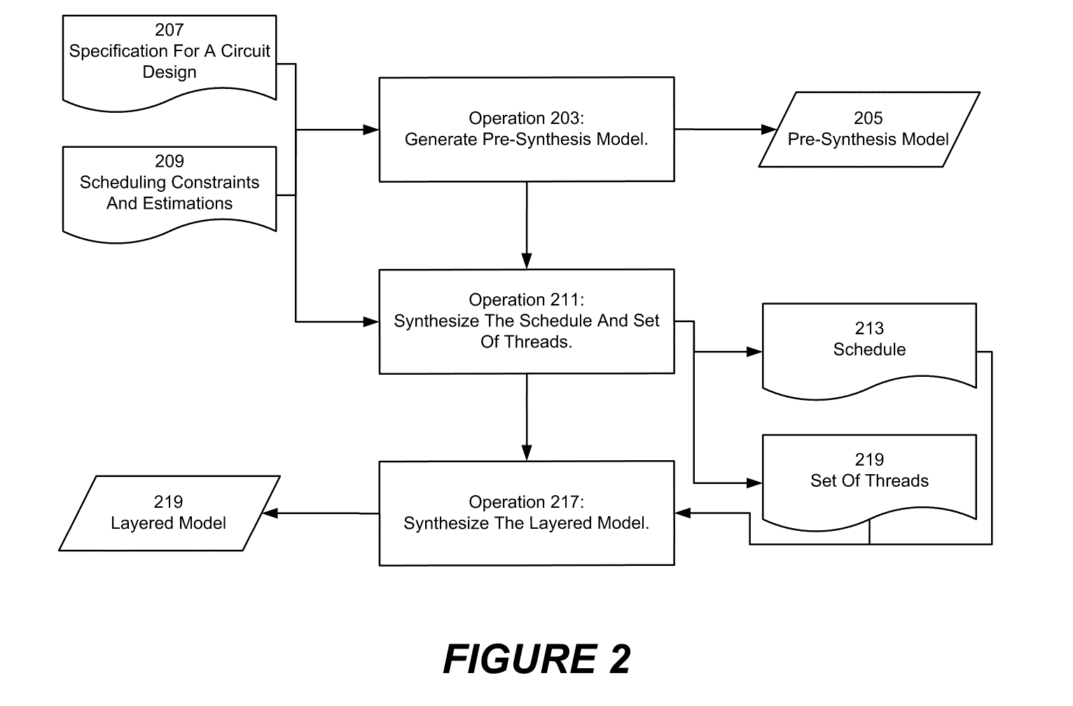

FIG. 2 illustrates a design flow 201 that may correspond to various implementations of the present invention. As can be seen from this figure, the design flow 201 includes an operation 203 for generating pre-synthesis models 205 from a circuit design specification 207 and a set of scheduling constraints and estimations 209. The pre-synthesis models 205 may then subsequently be used by a designer to perform debugging of the circuit design specification 207 and validation of the scheduling and synthesis constraints 209. In various implementations, the circuit design specification is computer executable code, written in C++, which behaviorally describes the intended functionality of the circuit. With some implementations, the operation 205 may randomly select some schedule parameters.

The method 201 further includes an operation 211 for synthesizing a schedule 213 and a set of threads 215 and an operation 217 for synthesizing a layered model 219 from the schedule 213 and the set of threads 215. The layered model 219 may then subsequently be used by a designer to simulate the behavior of the circuit design at a very high level of abstraction, yet still include various levels of timing accuracy.

### Layered Models for High-Level Synthesis

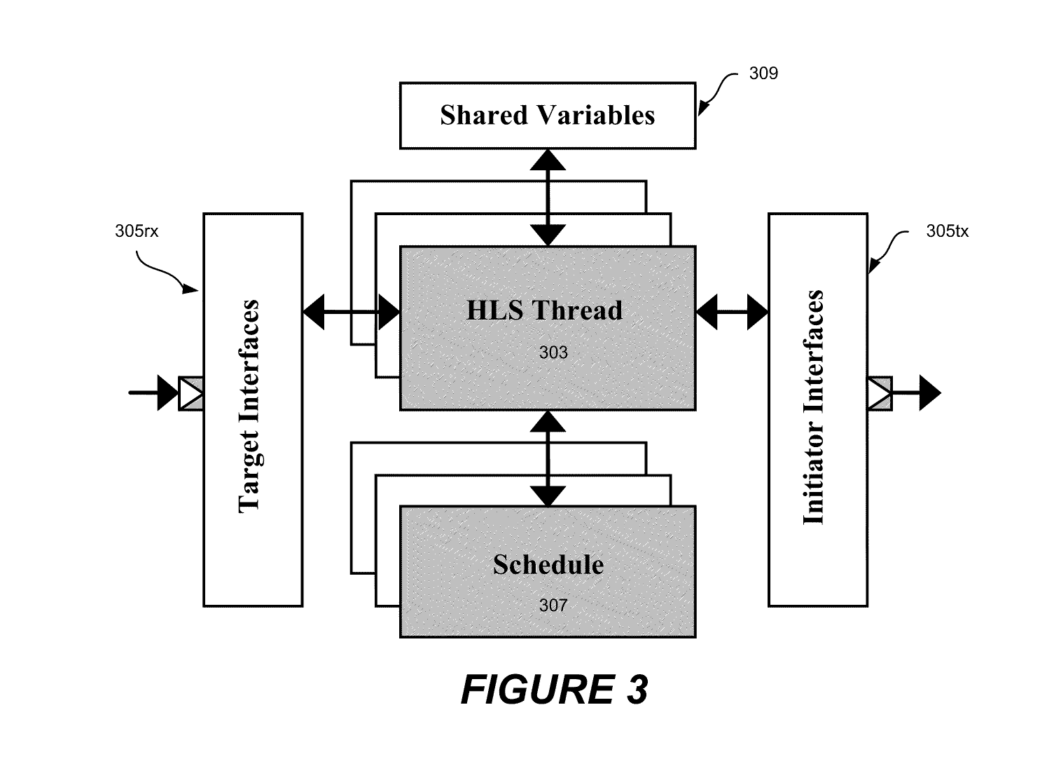

FIG. 3 illustrates a layered model 219 that may be generated by various embodiments of the present invention. As can be seen from this figure, the model 219 includes a set of threads 303, a target interface 305rx, an initiator interface 305tx, a schedule 307, and a shared variable 309. In various implementations, the various components, such as, for example, the target interface 305rx, are formed from a library of C++ classes.

### Layered Modeling Interfaces

In various implementations, the interfaces 305 (i.e. the target interface 305rx and the initiator interface 305tx) are register transfer level objects with corresponding SystemC simulation models, which were generated prior to the synthesis process. In alternative implementations, the interfaces 305 are synthesized from a high-level description of the circuit design under synthesis. With some implementations, the interfaces 305 comply with the transaction level modeling 2.0 standard, hereafter referred as “TLM 2.0,” which is described in OSCI TLM-2.0 User Manual, 2007-2008, Open SystemC Initiative, which user manual is incorporated entirely herein by reference. In further implementations, the interfaces 305 provide TLM 2.0 initiator and target sockets, based on sc_signal. As a result, communication with the model 219 is facilitated by calling read and write interface access methods, which both can be either blocking reads (as defined by the SystemC specification found the IEEE Standard SystemC Reference Language Manual in IEEE, Std 1666-2005) or non-blocking reads. As a further result, the interface 305 access methods may correspond to hardware ports in a synthesized design. More particularly, the core logical behavior, referred to as “core logic,” of the synthesized design (i.e. the logic described in the set of threads 303, which will be described in greater detail below) is connected to the logical behavior of the interfaces allowing open transfer of data between the interface logic and the core logic. Contrast this with conventional high-level synthesis, where core logic can communicate with interface logic only in a limited number of predefined ways.

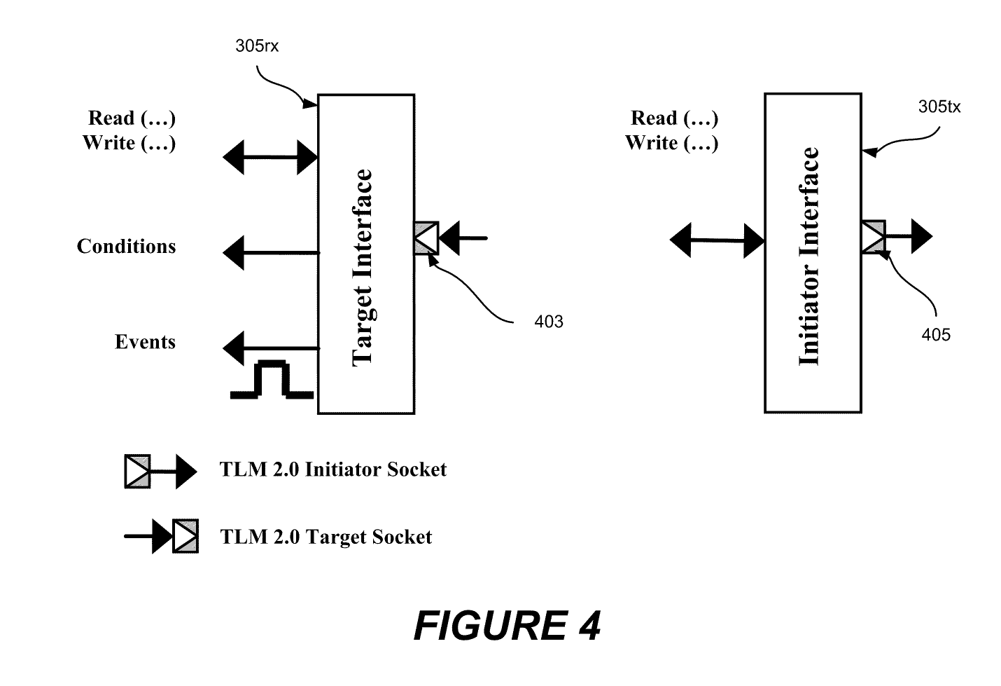

FIG. 3 illustrates two types of interfaces 305, the target interface 305rx and the initiator interface 305tx. The target interface 305rx and the initiator interface 305tx may be distinguished by the type of socket used. For example, with the implementations that comply with the TLM 2.0 standard, the interfaces may be distinguished by the type of socket employed by the particular interface 305. FIG. 4 illustrates the target interface 305rx having a socket 403 and the initiator interface 305tx having a TLM 2.0 socket 405. As can be seen from this figure, the socket 405 provides read and write access only. However, the socket 403 provides conditions and interface events in addition to read and write access. Use of conditions and events will be described in greater detail below.

In various implementations, the interfaces 305 may include an internal queue, such as, for example, a first-in first-out queue. Still, in some implementations, the interfaces 305 may include serial-to-parallel and parallel-to-serial converters.

### Layered Modeling Threads

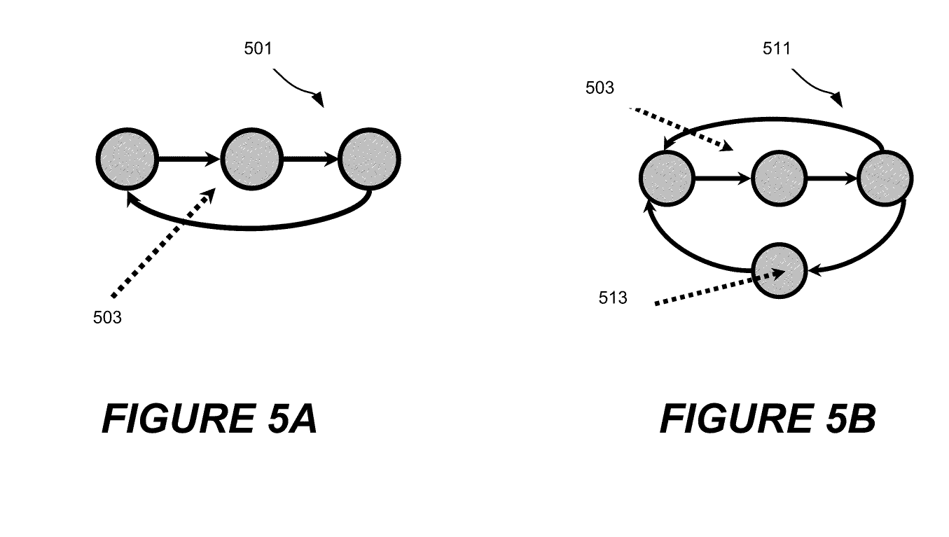

The set of threads 303 defines the behavior of the model 219. More particularly, the set of threads 303 describe particular responses to an input or a set of inputs which may be applied to the circuit design upon which the model 301 models. In various implementations, the set of threads 303 includes both free-running threads and event activated threads. FIG. 5A illustrates a free-running thread 501. As can be seen from this figure, the free-running thread 501 is a datapath controlled by a finite state machine (FSM) that has only active states 503. As a result, once a free-running thread becomes active, such as, for example, once a reset signal is de-asserted, the thread continues to run through its full execution cycle until it reaches a state that requires a blocking read or a blocking write. This concept is discussed in greater detail in Formalizing TLM with Communicating State Machines, by B. Niemann and C. Haubelt, Proceedings of Forum on Specification and Design Languages, 2006, pp. 285-292, which article is incorporated entirely herein by reference.

FIG. 5B illustrates an event activated thread 511. As can be seen from this figure, the event activated thread 511 is a finite state machine that has both active states 503 and inactive states 513. As those of skill in the art will appreciate, the finite state machine 511 may be realized by a combination between a while loop (i.e. the active states 503) and a wait statement (i.e. the idle states 513). The event activated thread 511 only becomes active if an event happens or a condition becomes true on the target interface 305rx. The event activated thread 511 will then execute. In various implementations, the event activated thread 511 will remain active until the condition becomes false. With some implementations, events and conditions that active an event activated thread 511 can be combined in “AND” and “OR” type thread sensitivity lists.

### Layered Modeling Shared Variables

In various implementations a shared variable is provided, such as, for example, the shared variable 309 illustrated in FIG. 3. The shared variable 309 provides an efficient means for ones of the set of threads 303 to communicate with each other without the need of going through interface components. With some implementations, a one of the set of threads 303 may write to the shared variable and another of the set of threads 303 may read from the shared variable. Still, with some implementations, a one of the set of threads 303 may increment the shared variable 309 while another of the set of thread 303 may decrement the shared variable 309.

In some implementations, the shared variable 309 is derived from the his_shared_variable base class, which defines a resolve function that should be defined in the derived class. This function resolves conflicts, such as, for example, race conditions, which may occur when two different threads are trying to write to the same shared variable 309 in the same clock cycle.

### Layered Modeling Scheduling

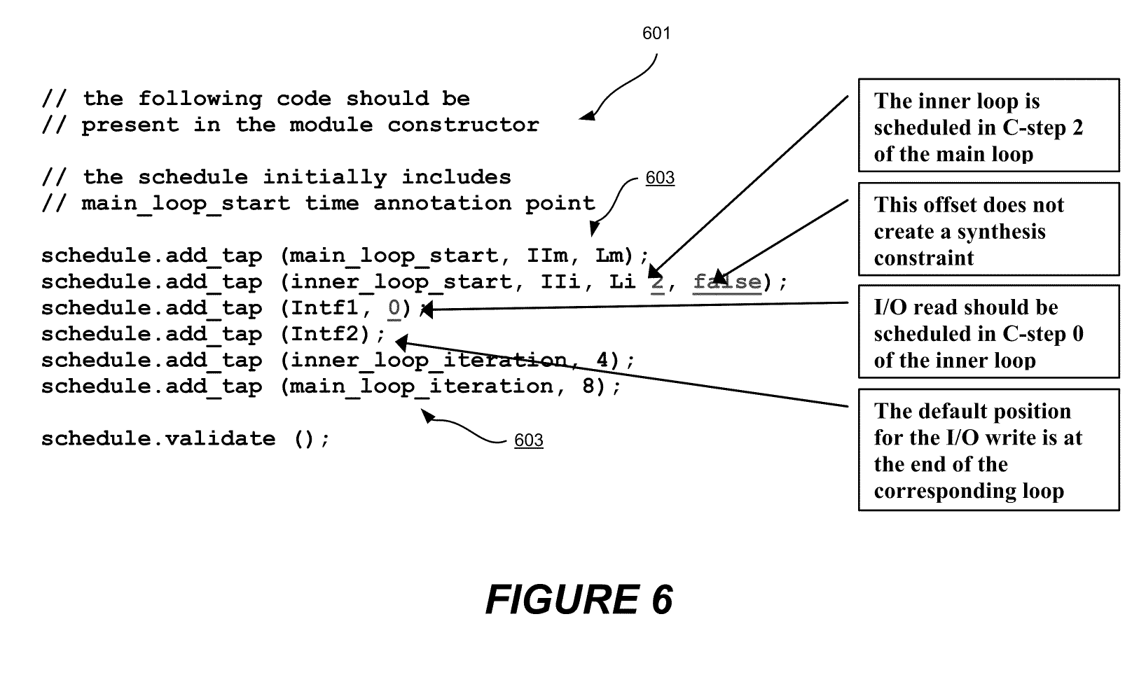

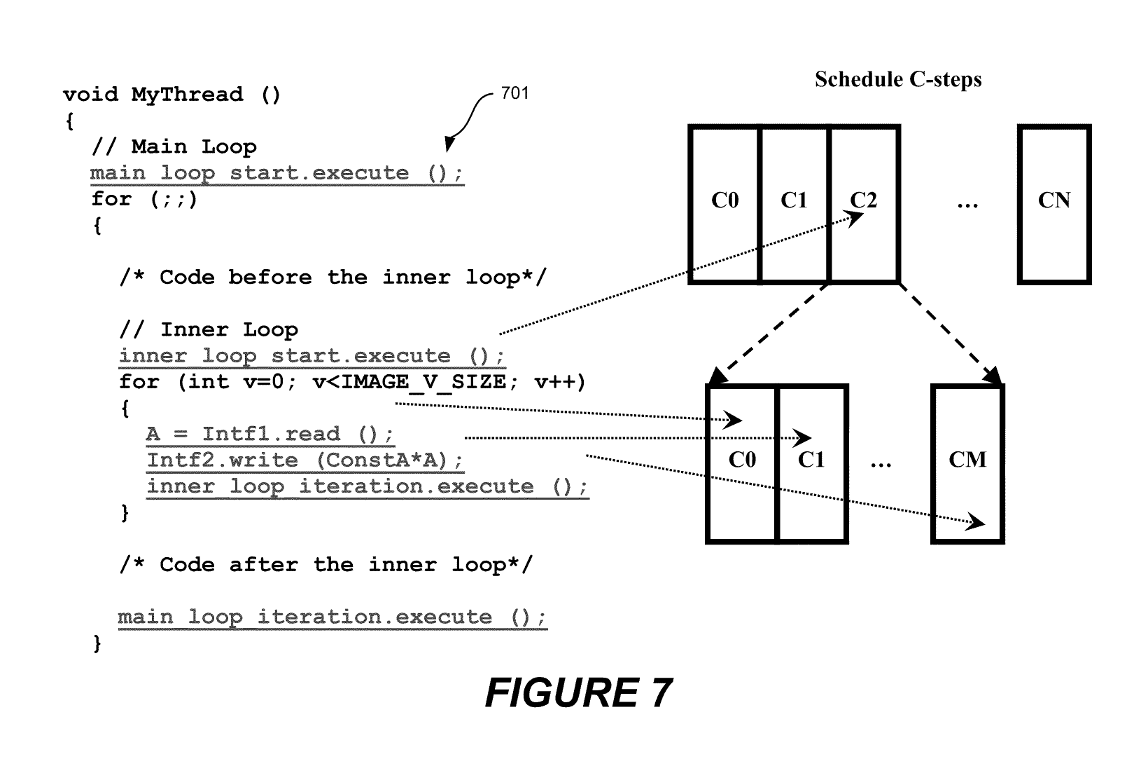

As stated above, the set of threads 303 does not include wait statements. Instead, timing of the threads execution is accomplished by the schedule 307. In various implementations, the schedule 307 includes a plurality of timing annotation points (TAP). FIG. 6 illustrates a schedule 601 that corresponds to a thread 701 shown in FIG. 7. As can be seen from these figures, the schedule 601 includes number of timing annotation points 603 that reference particular steps, referred to here as “C-Steps,” within the thread 701. In various implementations, the schedule 307 is assembled based on the timing annotation points when the module 219 is constructed. A benefit realized by the use of timing annotation points, which is not realizable by the use of wait statements, is the ability to pipeline operation and perform loop unrolling.

### Timing Accuracy Using Layered Models for High-Level Synthesis

As stated above, the layered model 219 may be used by a designer to simulate the behavior of the circuit design at a very high level of abstraction, yet still include various levels of timing accuracy.

In various implementations, the layered model 219 may be employed to perform approximately-timed simulation of the circuit design. More particularly, the schedule 213 and interfaces use wait (e.g. N*ClockPeriod) to correctly model the timing of ones of the set of threads 215. With some implementations, the interfaces 305 employ TLM 2.0 non-blocking transport for simulation of interface 305 protocols. In alternative implementations, the interfaces 305 employ TLM 2.0 Payload Event Queues for simulation of interface 305 protocols.

With some implementations, the layered model 219 may be employed to perform cycle-accurate at the transactions boundaries (CATB) simulation. More particularly, the interfaces 305 may employ TLM 2.0 non-blocking transport mechanisms. The main difference with approximately-timed modeling from CATB modeling is that at the CATB level, all TLM 2.0 non-blocking transport calls are synchronized to a clock. Ones of the set of threads 303 are sensitive to an edge of the clock and the schedule 307 and interfaces 305 exercise wait (N) calls (i.e. waits for a given number of clock cycles.) This abstraction level is an interim level between cycle-accurate and approximately-timed modeling. It may be useful for hardware verification after high-level synthesis. Cycle-accurate and the transactions boundary modeling and verification is discussed in greater detail in Formalizing TLM with communicating state machines, by B. Niemann and C. Haubelt, Proceedings of Forum on Specification and Design Languages, 2006, pp. 285-292, and Extending the Transaction Level Modeling Approach for fast Communication Architecture Exploration, by S. Pasricha et al., Proceedings of the 41^{st} Design Automation Conference, 2004, pp. 113-118, which article is incorporated entirely herein by reference.

Still, with some implementations, the layered model 219 may be employed to perform loosely-timed simulation. Loosely-timed simulation is facilitated by use of the SystemC global time quantum and local time quantum keepers, which are incorporated into the schedule 307. Threads may be run independently of each other with their local clock running ahead of the SystemC clock by use of virtual buffers in the interfaces 305. The local clocks may be advanced by exercising m_qk.inc (e.g. N*ClockPeriod) calls. With some implementations, the local time quantum keeper is incremented. In alternative implementations, a wait statement is used. In some implementations, context switching may occur (e.g. by implementing a wait statement). For example, it may be advantageous to switch the context if a virtual buffer overflows or underflows or if a thread explicitly calls for local clock synchronization. In loosely-timed simulation, the interfaces 305 employ TLM 2.0 blocking transport calls with time annotation to transfer data between modules.

Additionally still, with some implementations, the layered model 219 may be employed to perform un-timed simulation. More particularly, the layered model 219 can be used to support a fully un-timed simulation run by discounting the requirements of the schedule 307.

### Layered Modeling Tool for High-Level Synthesis

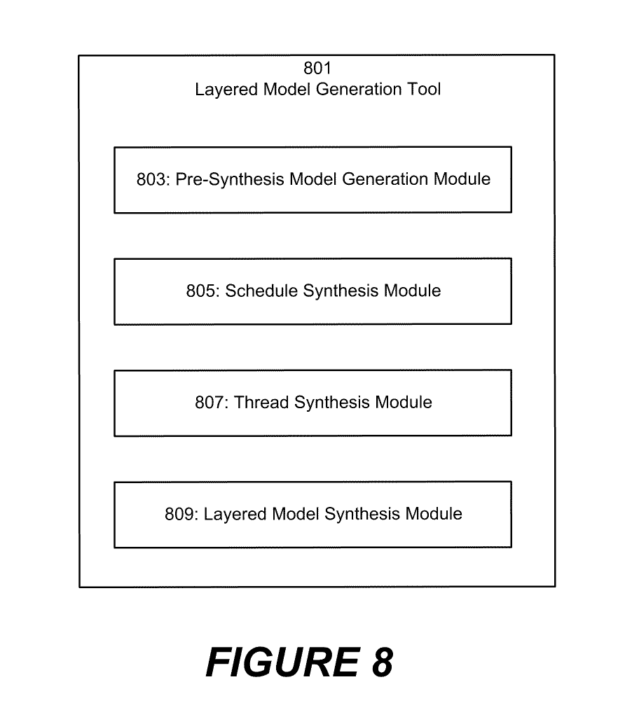

FIG. 8 illustrates a layered model generation tool 801 that may be provided by various implementations of the present invention. As can be seen from this figure, the tool 801 includes a pre-synthesis model generation module 803 that generates the pre-synthesis model 205 from the specification 207 and the scheduling constraints and estimations 209, a schedule synthesis module 805 that generates the schedule 213 from the scheduling constraints and estimations 209 and the specification 207, a thread synthesis module that generates the set of threads 219 from the specification 207, and a layered model synthesis module 809 that generates the layered model 219 from the schedule 213 and the set of the threads 219.

1. A circuit design simulation tool for simulating an output of at least a portion of a circuit design, the tool comprising:
a target interface module that receives an input;
a component module that matches the input to a user defined thread, the user defined thread corresponding to a portion of the circuit design;
a thread execution module that generates an output from the input by causing the user defined thread to be executed by a computing device; and
an initiator interface module that transmits the output;
whereby at least a portion of the circuit design may be simulated.

2. A computer implemented method for generating a model of an electronic design, the method comprising:
receiving a specification that functionally describes at least a portion of a circuit design;
generating a set of threads from the specification;
receiving a set of design constraints;
generating a schedule from the set of design constraints and the specification;
generating a layered model that is functionally equivalent to the portion of the circuit design from the schedule and the set of threads; and
saving the layered model to a memory storage device.

3. The computer implemented method recited in claim 2, the method act of generating a set of threads from the specification comprising:
identifying a plurality of operations defined by the specification; and
forming a finite state machine corresponding to each of the plurality of operations.

4. The computer implemented method recited in claim 3, the method act of generating a schedule from the set of design constraints and the specification comprising:
identifying a plurality of timing annotation points referenced within the specification; and
assembling the schedule based in part upon the plurality of timing annotation points.

5. The computer implemented method recited in claim 4, the method act of generating a layered model that is functionally equivalent to the portion of the circuit design from the schedule and the set of threads comprising:
forming a target interface for the layered model;
forming an initiator interface from the layered model;
connecting the set of threads to the target interface and the initiator interface; and
connecting the set of threads to the schedule.

6. The computer implemented method recited in claim 5, wherein the initiator interface comprises a socket having read and write capabilities;

7. The computer implemented method recited in claim 5, wherein the target interface comprises a socket having read, write, and event and condition receipt capabilities.

8. The computer implemented method recited in claim 4, wherein the plurality of timing annotation points are added to the specification by a synthesis tool.

9. The computer implemented method recited in claim 4, wherein the plurality of timing annotation points are added to the specification by a user.

10. The computer implemented method recited in claim 2, the specification being implemented in SystemC.

11. A computer program product for generating a model of an electronic design comprising:
software instructions that cause a computer to perform a set of operations; and
one or more computer readable media storing the software instructions;
the set of operations including:
receiving a specification that functionally describes at least a portion of a circuit design;
generating a set of threads from the specification;
receiving a set of design constraints;
generating a schedule from the set of design constraints and the specification;
generating a layered model that is functionally equivalent to the portion of the circuit design from the schedule and the set of threads; and
saving the layered model to a memory storage device.

12. The computer program product recited in claim 11, the operations for generating a set of threads from the specification comprising:
identifying a plurality of operations defined by the specification; and
forming a finite state machine corresponding to each of the plurality of operations.

13. The computer program product recited in claim 12, the operation for generating a schedule from the set of design constraints and the specification comprising:
identifying a plurality of timing annotation points referenced within the specification; and
assembling the schedule based in part upon the plurality of timing annotation points.

14. The computer program product recited in claim 13, the operation for generating a layered model that is functionally equivalent to the portion of the circuit design from the schedule and the set of threads comprising:
forming a target interface for the layered model;
forming an initiator interface from the layered model;
connecting the set of threads to the target interface and the initiator interface; and
connecting the set of threads to the schedule.

15. The computer program product recited in claim 14, wherein the initiator interface comprises a socket having read and write capabilities.

16. The computer program product recited in claim 14, wherein the target interface comprises a socket having read, write, and event and condition receipt capabilities.

17. The computer program product recited in claim 13, wherein the plurality of timing annotation points are added to the specification by a synthesis tool.

18. The computer program product recited in claim 13, wherein the plurality of timing annotation points are added to the specification by a user.

19. The computer program product recited in claim 11, the specification being implemented in SystemC.
